(19) United States
(12) Patent Application Publication
(10) Pub. No.: US 2006/0076083 A1
(43) Pub. Date: Apr. 13, 2006

(54) Lumber element and method for manufacturing the same

(75) Inventor: Jan-Erik Lindblom, Karlstad (SE)

Correspondence Address: GREER, BURNS & CRAIN, 300 S WACKER DR, 25TH FLOOR, CHICAGO, IL, 60606, US

(73) Assignee: STORA ENSO AB

(21) Appl. No.: 11/245,924

(22) Filed: Oct. 7, 2005

Related U.S. Application Data
(60) Provisional application No. 60/630,436, filed on Nov. 23, 2004.

(30) Foreign Application Priority Data
Oct. 7, 2004 (SE) 0402418-8

(51) Int. Cl. B27C 9/00; B27M 1/08; B27L 5/00; B27M 1/00

(52) U.S. Cl. 144/368; 144/364

(57) ABSTRACT

The present invention relates to a method for the manufacture of a lumber element comprising at least one outer surface, at least one edge surface and at least one outer corner. The method comprises steps to round off the outer corner and to provide it with grooves comprising parallel ridges (13) and tracks (14) in the grain direction of the lumber to improve the paint-absorbing ability of the surface. The invention relates also to a lumber element comprising at least one outer corner which is provided with such grooves.

### CLAIM FOR PRIORITY

This Application claims the benefit of U.S. Provisional Application No. 60/630,436 filed Nov. 23, 2004, which is hereby incorporated by reference.

The present invention relates to a lumber element comprising at least one outer surface, at least one edge surface and at least one outer corner as well as a method for manufacture of the same.

### BACKGROUND OF THE INVENTION

On re-sawing or breaking up of wooden logs many different types of lumber elements can be obtained, on the one hand regarding sizes, on the other hand regarding properties, depending on from which part of the cross-section of the log they are taken.

A timber log must be broken up in the raw state to avoid crack formation in the lumber when the log dries. The disadvantage of lumber elements that are sawn from raw wood, however, is that they shrink and warp, i.e. are deformed, when they later dry. For lumber with high demands on flatness and dimensional accuracy, which is almost always the case, it is therefore required that they are planed to the correct dimensions and flatness after drying.

For lumber that is to be used as facing or panelling on e.g. walls and ceilings, a planed surface is, however, a disadvantage since in any subsequent coating the paint has difficulty fastening to the smooth planed surface. The risk is simply that the painted layer becomes too thin. In this way the risk increases of the paint chipping off prematurely, with the subsequent need of repainting. Especially in the case of outdoor wooden siding, the weather protection can become insufficient so that the wood is attacked by rot.

In the production of facing panels that are intended to be painted, the panel boards have first been produced by dry sawing of the centre yields, i.e. the two rectangular lumber blocks that in normal cases are sawn out of the centre of each wooden log. After drying of these lumber blocks they are planed on each side to obtain correct dimensions and to correct the shrinking and deformation that occurs during drying. After planing the lumber blocks are sawn lengthwise to panel boards of required thickness. Each such panel board obtains thus at least one sawn surface with coarse surface structure which is suited for use as an outer surface of a panel board, in that its ability to absorb paint is good. The edge surfaces of these panel boards still have however a smooth, planed surface and as well sharp outer corners to which paint has difficulty fastening.

Furthermore, using the centre yields for the production of panel boards is a waste of resources since it should otherwise be possible for these be used for the production of thicker lumber elements with e.g. load-bearing function.

From each wooden log is obtained furthermore usually at least four side boards from the area outside of the centre yield. These side boards have mainly so-called lying annual rings, i.e. annual rings that extend along the plane of the board, and have as well usually closer annual rings than the centre yield, which is why shrinking and hence deformation is considerable on drying. Plane machining, i.e. planing of the side boards, is therefore necessary before they can be used for any purpose where dimensional accuracy and flatness are important. At the same time planing, as was earlier mentioned, gives smooth surfaces, which makes them unsuitable as panel boards intended for painting. This is a large disadvantage since side boards of e.g. fir have higher resistance to rot than wood from the centre yield, their often closer annual rings make the wood harder, and the number of knots is often less than in the centre yield.

For all types of wooden elements intended for painting, the outer corners make up a further special problem. Sharp corners formed between two sawn surfaces, e.g. at 90° to each other, have in principle no paint-retaining effect at all but rather form a gateway for rot in the lumber and are as well a disadvantage in manual handling of the lumber as they increase the risk for damage. If on the other hand the outer corners are rounded off, as generally takes place with planed lumber, a smooth surface is formed which also lacks good paint-absorbing capacity.

### BRIEF DESCRIPTION OF THE INVENTION

The invention relates to a method for the manufacture of lumber elements, which eliminates the above problems and with which at least one outer corner is formed with good paint-absorbing or paint-retaining ability. At least this aim is reached through a method for the manufacture of a lumber element comprising at least one outer surface, at least one edge surface and at least one outer corner wherein the outer corner is rounded off and provided with at least one groove comprising parallel ridges and tracks in the grain direction of the wood to improve the paint-absorbing ability of the surface.

The invention relates as well to a lumber element that is embodied with at least one outer corner that exhibits good paint-absorbing or paint-retaining ability. At least this aim is reached through a lumber element comprising at least one outer surface, at least one edge surface and at least one outer corner wherein the outer corner is rounded off and provided with at least one groove comprising parallel ridges and tracks in the grain direction of the lumber element to improve the paint-absorbing ability of the wood.

Fundamental to the invention is thus the insight that a good paint-absorbing ability of the outer corner of a lumber element can be achieved by rounding off the corner and supplying it with grooves that preferably are so shallow that the grooving becomes invisible to the naked eye when normal top paint coating, e.g. a base coat layer and two finishing coat layers, is used.

According to one embodiment of the invention, a lumber surface is also provided with grooves to achieve a good paint-absorbing ability of the surface. These grooves also are preferably so shallow that the grooving becomes invisible to the naked eye when normal top paint coating is used. The lumber surface can consist of an edge surface and/or an outer surface.

Within the scope of the invention, the grooves can have different shape and size. The number of grooves can vary depending on the size of the corner or the surface to be grooved. Common to all embodiments is however that the grooves are executed along the grain direction of the wood to avoid unnecessary cutting of single fibres, which would imply an increased risk of moisture penetration. In the preferred embodiment the grooves are wave-shaped, whereby the ridges formed have a rounded top in cross-section and the tracks formed have a rounded bottom in cross-section. As a rule it is preferred that the tops of the ridges are softly rounded or planar so as to enable proper covering with paint, while pointed or saw-toothed ridges are less suitable. It should however be possible to execute the grooving with a cross-section in the form of sector-shaped ridges, which are placed next to each other so that they meet in a pointed angle to form the tracks. A trapeze-shaped grooving, i.e. ridges and tracks which are embodied with inner perpendicular, planar limiting surfaces, should also be possible. The dimensions of the ridges also can be varied according to need. In a preferred embodiment the centre distance between two adjacent ridges is less than 2 mm, preferably less than 1 mm and most preferably about 0.75 mm. The depth of the grooving, i.e. the distance between the tops of the ridges to the bottoms of the tracks, is in the preferred embodiment less than 1 mm, preferably less than 0.5 mm and most preferably less than 0.25 mm.

Further the grooving can be achieved in different ways. In a preferred embodiment the grooving can be made by means of a cutter with a rotating cutter tool with groove-profiled cutting edge. A splinter-free surface is in this way obtained, which eases manual handling of the lumber and as well giving the lumber an attractive appearance. With the help of a cutter it is also possible to manufacture the wooden element with high dimensional accuracy and flatness, i.e. the tops of the ridges are located in essentially the same plane. It should however also be possible to achieve the grooving in another way, e.g. by rolling with grooved rolls or scribing the surface with the help of a suitable, preferably rotating, scribing tool. The latter-named procedure would however give a significantly rougher and less attractive surface.

Within the scope of the invention, the rounded surface on an outer corner of a lumber element or some arbitrary wooden surface can be provided with a grooving to improve the paintability. In this way e.g. panel boards produced in the usual way from a centre yield can be provided with grooves. Furthermore, the surface need not be planar; it would also be possible for it to be, for example, the outer surface of a round post.

In a preferred embodiment however, the procedure according to the invention is used to produce panel boards from the side yield or the side boards of a log. As was earlier mentioned the side yields of e.g. fir have higher resistance to rot than the centre yields. Similar conditions can apply as well for certain other types of wood, but within the scope of the invention the side boards can be taken out, according to the method described below, from all arbitrary wood types. A major advantage of the method is that it results in a better resource utilization in that the usefulness of edge boards increases.

After sawing of such a side board it is dried using a generally known method, and becomes therefore deformed due to shrinking so that the heart side, i.e. the side which was facing the centre of the log, becomes convex, while the sapwood side, i.e. the side which was facing the outer surface of the log, becomes concave. This board is then post-treated according to a method in which the heart side is grooved and plane-machined with the assistance of a groove-forming cutter tool in such as way that the tops of the ridges become situated in essentially the same plane. In the same way the side edges are grooved and plane-machined and the outer corners rounded off, with grooves on the rounded corners as well. The side-edge machining and the corner rounding can be suitably executed with one and the same tool. The sapwood side of the board can be plane-machined and possibly provided with grooves in a corresponding way, however according to a preferred embodiment the sapwood side of the board is not plane-machined but instead the already existing concave surface is accentuated with the help of a concave cutter tool. This is not, however, carried out over the entire surface, but only in a central area, while approximately 0.5-2 cm of each edge area is left unmachined. This side of the board will serve as the backside of a facing panel and therefore needs no grooving since it will not be painted. Further, as a result of the natural shrinking the outer edge areas will have a weakly pointed angle relative to the side surfaces, which results in the contact and sealing to the foundation, e.g. the outside of another panel board, being very good, which is advantageous in that, among other advantages, it resists the penetration of moisture. Through a such concave machining of a surface that is usually already concave, the advantage is obtained that all panel boards are uniform even if they have a varying degree of concavity after drying. At the same time such a method saves material since no material is removed from the thickest cross-section of the board, i.e. adjacent to the edge areas, and the boards therefore do not need to be taken out with any allowance when sawing.

An outer corner or a lumber surface executed according to the present invention gives a surface with very good painting properties, both for brush painting and for spray painting. The concept “paint”, as it is used here, is to be interpreted widely and need not necessarily be a cover paint but can also be a transparent varnish, oil or an impregnating agent. Thus in such surface treatment the grooves of the wood will at the end not be hidden by the paint, but rather will form an attractive surface structure in the wood. The grooving will result in increased penetration ability of oil and impregnating agents. For varnish as for cover paint, the grooving results in a larger adhesive surface which contributes to increased adhesion and decreased risk for flaking. A lumber element manufactured according to the invention is especially suitable for use as panelling on walls and ceilings, and particularly as cover-painted outer wall siding. Lumber elements with grooved surfaces should however be able to find many other application areas, such as for furniture manufacture or as flooring on e.g. wharves and outdoor areas where the grooving would contribute in an advantageous way to decreasing the risk of slipping.

### BRIEF DESCRIPTION OF THE DRAWINGS

The invention will now be described more closely with reference to the accompanying drawings, in which:

FIG. 1 a schematic end view of a timber log, which shows a possible main principle for re-sawing of the raw timber log,

FIG. 2 an end view of a side board, which shows the deformation of the board after drying,

FIG. 3 a schematic end view of the side board during plane-machining of the top surface with a groove-profiled cutter tool

FIG. 4 an end view of the side board during machining of the underside using a convex cutter tool,

FIG. 5 an end view of the side board during side edge machining and corner-rounding using two opposing groove-profiled cutter tools,

FIG. 6 a detail enlargement of a corner area of the side board which shows the grooved profile of the outer surfaces

FIG. 7 a further enlarged detail of a wooden surface which shows the shaping of the grooving more closely, and

FIG. 8 a schematic cross-section through a wall panel made up of side boards produced in accordance with the invention.

### DETAILED DESCRIPTION OF THE INVENTION

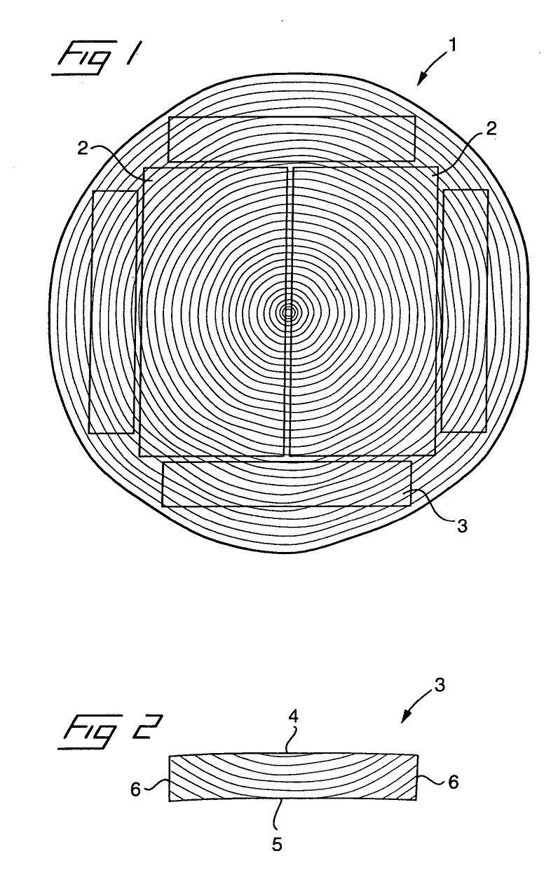

First reference is made to FIG. 1 in which is shown a possible main principle for the breaking up of a timber log 1 in raw condition. According to this principle, a centre yield is taken out from each log, by which the cross-sectional dimensions of the centre yield correspond approximately to the largest square that can be taken out within a circle corresponding to the diameter of the narrow end of the log. The centre yield is in turn divided into two parts 2 by a saw section through the heart of the wooden log. If the heart is left in some lumber element during drying, the crack formation increases drastically. In the area outside of the centre yield there is as a rule the possibility of taking out at least a side board 3 on each side of the centre yield, which has less width than the centre yield.

The sawing according to FIG. 1 takes place while the timber log is still raw, and after the sawing all surfaces are planar and all angles are perpendicular. However during drying the lumber element shrinks and is deformed. Especially large is the deformation of the side boards 3. This is partly a consequence of the orientation of the annual rings in the board, and partly due to the fact that the thickness of the annual rings is often less in the outer part of the timber log cross-section. In FIG. 2 is shown the deformation of the edge board on an exaggerated scale after drying of the same. As is shown the heart side 4 of the edge board, i.e. the side which was facing inwards towards the centre of the log, will bulge outwards, i.e. become convex, while the sapwood side 5, i.e. the side which was facing the outer surface of the log, will curve inwards, i.e. become concave. The corner angles between a side edge 6 and the heart side 4 or the sapwood side 5 will also be changed so that they as a rule are no longer perpendicular. The deformation of the side boards during drying means however that these must be post-treated such that they can be used for such purposes where flatness and dimensional accuracy are significant. In FIG. 3 is shown according to the invention a first stage of machining of the heart side or front side of the side boards 4, i.e. the side that is intended to be facing outwards in a facing panel and that as a rule is intended to be surface treated, e.g. coated with cover paint. The heart side 4 is plane-machined here by means of a schematically shown rotating cutter tool 7. To avoid a completely smooth and slippery surface onto which the paint has difficulty penetrating and adhering, the cutting edge of the cutter tool is groove-profiled to give a grooved lumber surface, which will be described in more detail further on. The plane-machining of the lumber surface is therefore be interpreted such that the tops of the groove ridges will end up in the same plane.

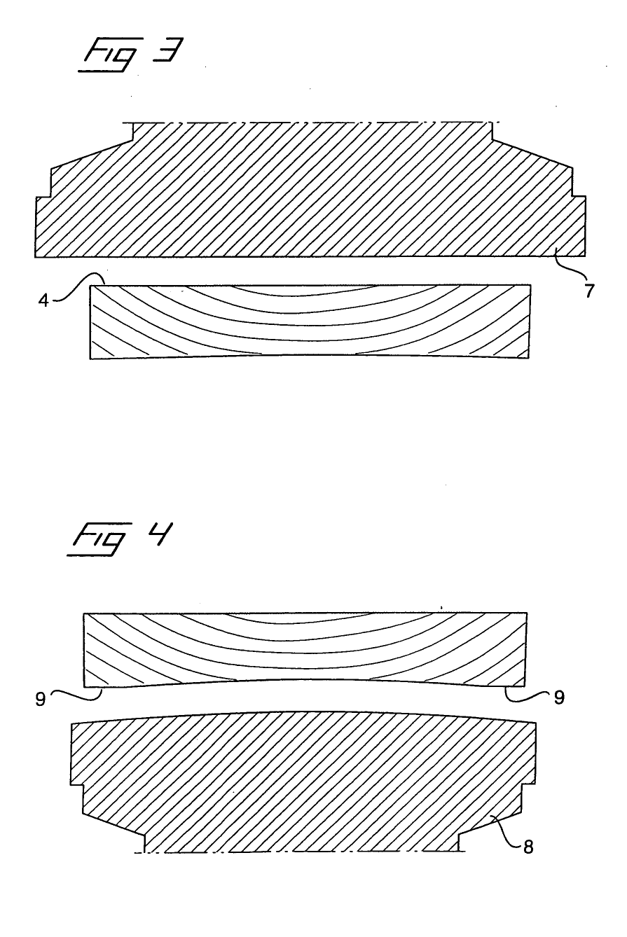

As was earlier mentioned the sapwood side 5 of the side board is concave after drying. According to a preferred embodiment of the invention this concavity is maintained and accentuated as is illustrated in FIG. 4. In this machining step a rotating cutter tool 8 is used that has a convex cutting edge that is used to accentuate the concave form of the sapwood side through machining of a central area of this surface. However an edge area 9 is left unmachined at each side edge. Through such a formation the side board will on mounting come into contact with a foundation, e.g. underlying panel boards, to seal tightly against the foundation and resist in this manner penetration of moisture. The sealing is facilitated by the unmachined edge areas 9 as a rule having an angle in relation to the side edges 6 that is smaller than 90° as a result of the deformation during drying. In a preferred form the concave machining takes place to a depth of 1-3 mm, preferably to approximately 2 mm from the plane of the outer edge area.

Thereafter FIG. 5 is referred to, in which is shown the machining according to the invention of the side edges 6 of the side board and the outer corners 10 between the side edges 6 and the heart side 4. This occurs by means of two opposite rotating cutter tools 11, which each display an edge side with a curved part 12 that can also round off the outer corners 10 at the same time as machining of the side edges. The radius of the curved cutting part 12 can suitably be approximately 1.5 mm. Similar to those of the cutter tool 7, the cutter tool cutting edges 11 are groove-profiled, also in the curved cutting part 12, to give the wooden surfaces good paint-absorbing ability.

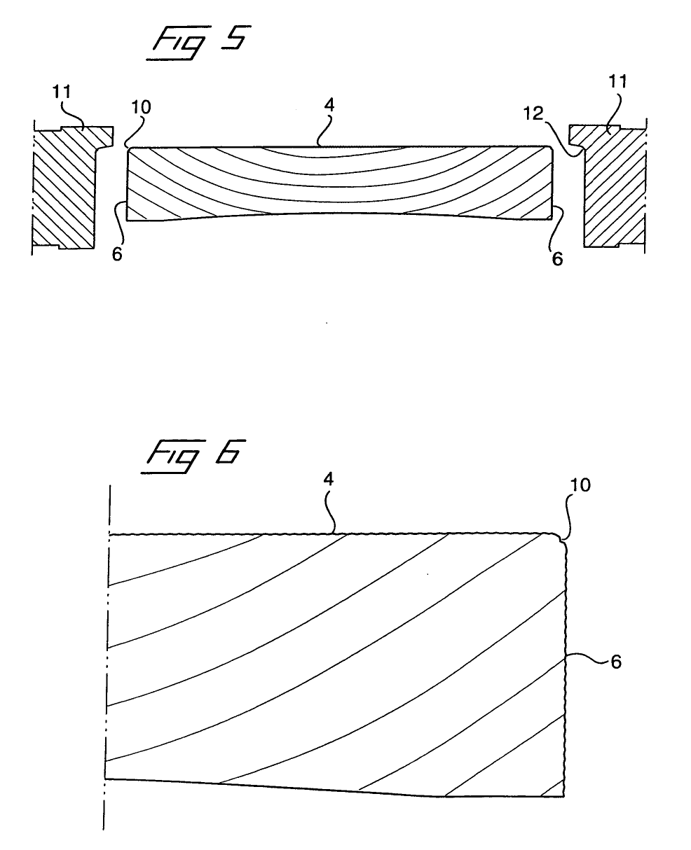

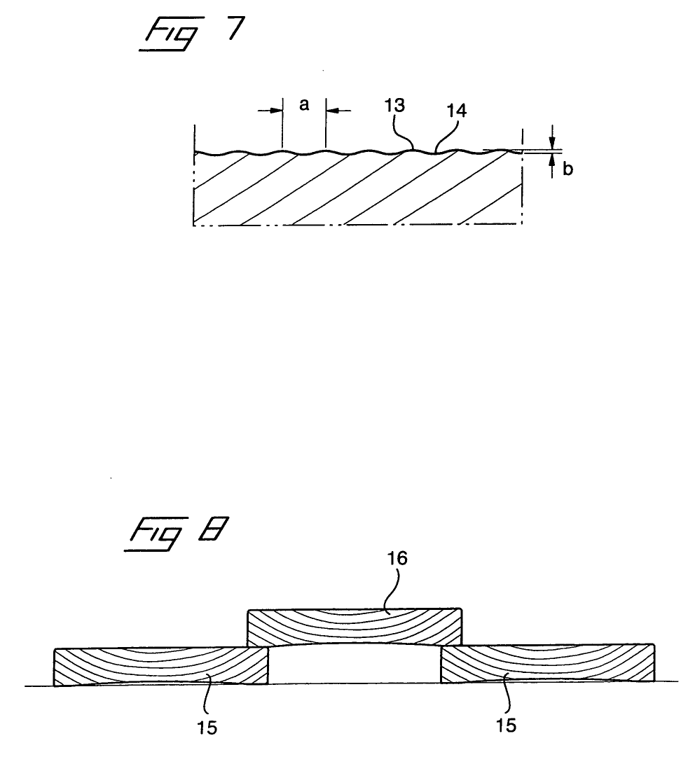

FIG. 6 shows a detail enlargement of an outer corner area of FIG. 5, in which the grooving in the lumber surfaces 4, 6 and the outer corner 10 are shown, and FIG. 7 illustrates the cross-sectional form of the grooving more closely through a further enlargement of a lumber surface. As the drawings make clear, the grooving in the preferred execution has the form of a sine wave, with the same radius of curvature of the tops of the groove ridges 13 as that of the bottoms of the groove tracks 14. In the preferred execution the distance a between the centres of two adjacent grooves is less than 2 mm, preferably less than 1 mm, and most preferably approximately 0.75 mm, while the depth b between the tops 13 of the ridges and the bottoms 14 of the tracks is less than 1 mm, preferably less than 0.5 mm, and most preferably less than 0.25 mm.

In FIG. 8 is shown a possible use of the lumber element according to the invention, such as panel board in a cover boarding. In such a cover boarding, a number of bottom boards 15 are attached to a foundation, e.g. a framework, at a distance from each other. The interstitial space between the neighbouring bottom boards is thereafter covered by the covering boards 16. In the use of panel boards of the type described earlier, all outward-facing surfaces will exhibit a grooving with good paint-absorbing ability and the contact between the bottom boards 15 and the covering boards 16 will be very tight as a result of the concave design of the panel boards.

It must be realized that the earlier described machining stages according to FIGS. 3-5 can be suitably carried out at essentially the same time and in one and the same machine.

Instead of using side boards for the manufacture of panel boards in the manner described earlier, it would of course also be possible to saw the panel boards out of the centre yields 2 after drying of these. The front sides of the panel boards acquire thereby a sawn surface with good paint-absorbing ability, as described earlier. Such panel boards would nevertheless only require a machining of the side edges for adjustment of dimensions and angles, and for a rounding off of the outer corners, as well as simultaneous grooving of the side edges and outer corners for improved paint-absorbing ability.

The described preferred embodiment is only exemplifying and within the scope of the invention an arbitrary number of defined surfaces can be provided with grooves. To execute the back sides of the panel boards with concave form is only one example of a possible execution and this side can according to the invention thus be left unmachined, planed or grooved according to requirement.

1. A method for the manufacture of a lumber element comprising at least one outer surface, at least one edge surface and at least one outer corner wherein the outer corner is rounded off and provided with at least one groove comprising parallel ridges and tracks in the grain direction of the wood to improve the paint-absorbing ability of the surface.

2. A method according to claim 1, wherein said at least one edge surface is provided with grooves.

3. A method according to claim 1, wherein at least one outer surface is provided with grooves.

4. A method according to claim 1, wherein said grooving is executed to a depth (b) of the track bottoms relative to the ridge tops that is less than 0.5 mm.

5. A method according to claim 1, wherein the grooves are executed such that they are not visible to the naked eye after coating with top paint.

6. A method according to claim 1 comprising the steps;
sawing the lumber element in a raw condition;
drying the lumber element, by which the same obtains deformation in such a way that a heart side of the same becomes convex-shaped while a sapwood side becomes concave-shaped;
providing the heart side with grooves; and
accentuating the concave form of the sapwood side through a removal of material, concave machining of a central area of the sapwood side.

7. A lumber element comprising at least one outer surface, at least one edge surface and at least one outer corner wherein the outer corner is rounded off and provided with at least one groove comprising parallel ridges and tracks in the grain direction of the lumber element to improve the paint-absorbing ability of the wood.

8. A lumber element according to claim 7, wherein at least one edge surface is provided with grooves.

9. A lumber element according to claim 7, wherein said at least one outer surface is provided with grooves.

10. A lumber element according to claim 7, wherein the grooves have a depth (b) measured from the bottoms of the tracks to the tops of the ridges that is less than 0.5 mm.

11. A lumber element according to claim 7, wherein the lumber element comprises a heart side and a sapwood side, whereby the heart side is provided with grooves while the sapwood side is concavely bent inwards by a material-removing machining of a central area to reinforce a natural concave inward bending of the sapwood side that arises after drying of the lumber element.

12. A method according to claim 1, wherein the grooves have a depth (b) measured from the bottoms of the tracks to the tops of the ridges that is less than 0.25 mm.

13. A lumber element according to claim 7, wherein the grooves have a depth (b) measured from the bottoms of the tracks to the tops of the ridges that is less than 0.25 mm.

14. A method for the manufacture of a lumber element comprising the steps,
sawing the lumber element in a raw condition; drying the lumber element, by which the same obtains deformation in such a way that a heart side of the same becomes convex-shaped while a sapwood side becomes concave-shape
accentuating the concave form of the sapwood side through a removal of material by concave machining a central area of the sapwood side;
rounding the outer corners of the heart side of the lumber element; and
grooving the heat side and outer corners of the lumber element in the grain direction of the wood to improve the paint-absorbing ability of the surface.
